(19) United States
(12) Patent Application Publication
(10) Pub. No.: US 2026/0040406 A1
(43) Pub. Date: Feb. 5, 2026

(54) PROTECTION DEVICE

(71) Applicant: Polytronics Technology Corp., HSINCHU (TW)

(72) Inventors: Tong Cheng TSAI, Taoyuan City (TW); Tsung Min SU, Hsinchu City (TW); Chia Mao CHEN, Toufen City (TW)

(21) Appl. No.: 19/058,338

(22) Filed: Feb. 20, 2025

(30) Foreign Application Priority Data
Jul. 30, 2024 (TW) 113128234

(51) Int. Cl. H05B 1/02

(52) U.S. Cl. CPC H05B 1/0205

(57) ABSTRACT

A protection device includes a substrate, a heater, and a meltable member. The heater includes a first heating element and a second heating element, disposed on the top surface and the bottom surface of the substrate, respectively. If a surface area of the substrate is taken as 100%, the sum of surface areas of the first and second heating elements accounts for 18% to 72%. The meltable member is disposed above the first heating element, by which the meltable member is heated up in the event of over-voltage.

### BACKGROUND OF THE INVENTION

### (1) Field of the Invention

The present application relates to a protection device, and more specifically, to a protection device having two heating elements.

### (2) Description of the Related Art

Fuses containing low melting point metals, such as, lead, tin or antimony, are well-known protection devices to cut off currents. To prevent over-current and over-voltage, various protection devices are continuously developed. For example, a device containing a substrate on which a heating layer and a low melting point metal layer are stacked in sequence. The heating layer heats up in the event of over-voltage, and then the heat is transferred upwards to the low melting point metal layer. As a result, the low melting point metal layer is melted and blown to sever currents flowing therethrough, so as to protect circuits or electronic apparatuses.

Recently, mobile apparatuses such as cellular phones and laptop computers are widely used, and people increasingly rely on such products over time. However, burnout or explosion of batteries of cellular phones or portable products during charging or discharging is often seen. Therefore, the manufacturers continuously improve the designs of over-current and over-voltage protection devices to prevent the batteries from being blown due to over-current or over-voltage during charging or discharging.

In a known protection device, a fuse containing a low melting point metal layer is in series connection to a power line of a battery, and the low melting point metal layer and a heating layer are electrically coupled to a switch and an integrated circuit (IC) device. When the IC device detects an over-voltage event, the IC device enables the switch to “on”. As a result, the current flows through the heating layer to generate heat to melt and blow the low melting point metal layer, so as to sever the power line to the battery for over-voltage protection. Moreover, it can be easily understood that the fuse itself can be heated and blown by a large amount of current in the event of over-current, and therefore over-current protection can also be achieved.

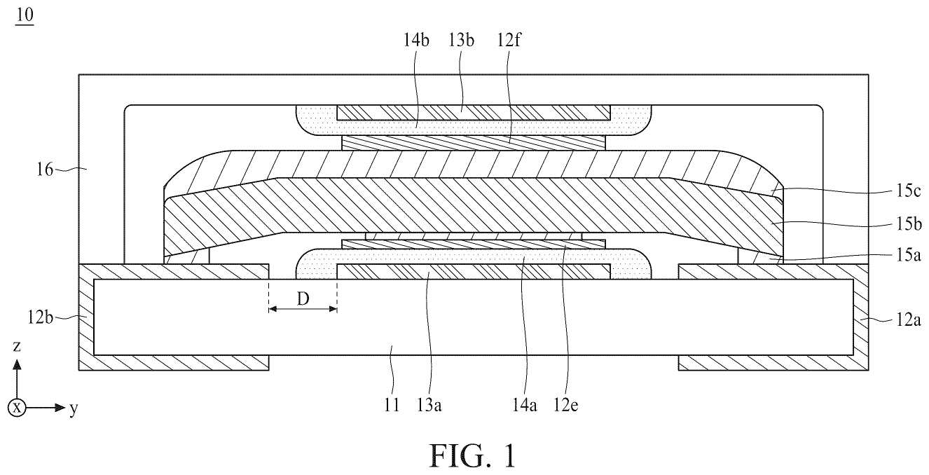

Please refer to FIG. 1, which shows a cross-sectional view of a known protection device 10. The major components of the protection device 10 include a substrate 11, a heater consisting of a first heating element 13a and a second heating element 13b, and a fuse consisting of a core metal layer 15b and a top covering layer 15c. A connecting layer 15a is disposed on the surfaces of a first electrode 12a, a second electrode 12b, and a bottom auxiliary electrode 12e disposed on the substrate 11. Through the connecting layer 15a, both ends of the core metal layer 15b is connected to the first electrode 12a and the second electrode 12b, respectively, while its center part is connected to the bottom auxiliary electrode 12e. The first electrode 12a and the second electrode 12b are electrically connected to an input terminal and an output terminal of a power supply. Thus, the fuse is connected in series with the electronic apparatus to be protected (such as a battery). When the current or temperature becomes excessively large or high, the fuse is heated up and consequently blown. The first heating element 13a is positioned beneath the fuse and is covered by a bottom insulating layer 14a. The second heating element 13b is positioned above the fuse, disposed on the cover member 16, and is covered by a top insulating layer 14b. A top auxiliary electrode 12f is connected to the top covering layer 15c. The fuse and the heater are connected to a switch and a detecting unit (not shown). If the detecting unit detects an over-voltage event, the switch enables the heater to be electrically conductive. The current flows through the heater to generate heat to melt and blow the fuse.

In order to reduce the blowing time, the surface area of the heater may be increased, thereby enhancing the heating rate. However, this approach encounters at least two issues.

First, on a single horizontal plane, the surface area of the heater is limited due to the surrounding components. For instance, to prevent a short circuit, the first heating element 13a must be spaced apart from the electrode 12b by a distance D, regardless of whether the bottom insulating layer 14a is present or not. Besides the aforementioned electrode 12b, other functional components on the substrate 11 may also contribute to limiting the surface area of the first heating element 13a.

Second, even if the heater is added on different planes to increase its surface area, there are still issues of high process complexity and component damage. For example, in order to prevent the heater from burning out itself, the heater with a larger surface area is divided into the first heating element 13a and the second heating element 13b, which are disposed on two substrates, that is, the substrate 11 and the cover member 16, respectively. However, this design results in additional burden during the manufacturing process of the heater. More specifically, the first heating element 13a and its associated components (i.e., electrodes, insulating layers, etc.) must be independently manufactured on the substrate 11, while the second heating element 13b and its associated components (i.e., electrodes, insulating layers, etc.) must be independently manufactured on the cover member 16. In other words, the heating elements of the heater are produced on two separate production lines, which makes the manufacturing steps more complex. This issue becomes particularly significant during mass production. Moreover, the heat generated by the first heating element 13a and the second heating element 13b flows upward and accumulates at the cover member 16. If one of the heating sources (i.e., the second heating element 13b) is directly placed on the cover member 16, the cover member 16 is at risk of cracking. In another scenario, if the cover member 16 is inherently fragile, it is also at risk of cracking or even exploding if the applied voltage or power to the second heating element 13b is not carefully controlled.

Accordingly, there is still room for improvement in the protection devices.

### SUMMARY OF THE INVENTION

The present invention provides a fast-acting protection device. In this protection device, a heater includes a plurality of heating elements placed on the same substrate. The combined surface area of the heating elements is controlled within a certain range, thereby accelerating the blowing time of a meltable member while maintaining the structural integrity of the surrounding components (i.e., components other than the meltable member). Additionally, the heater can withstand higher power and voltage, preventing itself from burning out instantly during operation, which could otherwise lead to incomplete blowout of the meltable member. More importantly, the heating elements are made on the same substrate, reducing the complexity of the manufacturing process while enhancing the device's performance as previously mentioned.

In accordance with an aspect of the present invention, a protection device includes a substrate, a heater, and a meltable member. The substrate has a top surface and a bottom surface opposite to the top surface. The heater includes a first heating element disposed on the top surface and a second heating element disposed on the bottom surface. The substrate has a first surface area. The first heating element has a second surface area, and the second heating element has a third surface area. If the first surface area is taken as 100%, the sum of the second surface area and the third surface area ranges from 18% to 72%. The meltable member is disposed above the first heating element, by which the meltable member is heated up and blown by the heater during an over-voltage event.

In an embodiment, the sum of the second surface area and the third surface area ranges from 42% to 70%. At an applied power of 14 W, the meltable member is blown in 15 seconds. At an applied power of 43 W, the meltable member is blown in 5 seconds.

In an embodiment, a ratio of an electrical resistance of the first heating element divided by an electrical resistance of the second heating element is equal to or less than 2.

In an embodiment, the aforementioned ratio of the electrical resistance of the first heating element divided by the electrical resistance of the second heating element ranges from 1 to 1.6.

In an embodiment, the second surface area of the first heating element is equal to the third surface area of the second heating element.

In an embodiment, the second surface area of the first heating element is smaller than the third surface area of the second heating element.

In an embodiment, the protection device further includes an electrode set. The electrode set has a first electrode, a second electrode, a third electrode, and a fourth electrode. The first electrode and the second electrode are disposed opposite on the substrate, and the third electrode and the fourth electrode are disposed opposite on the substrate. Two terminals of the meltable member are connected to the first electrode and the second electrode, respectively. Two terminals of the first heating element are connected to the third electrode and the fourth electrode on the top surface of the substrate. Two terminals of the second heating element are connected to the third electrode and the fourth electrode on the bottom surface of the substrate, by which the first heating element and the second heating element are electrically connected in parallel.

In an embodiment, the electrode set extends inward from an edge of the top surface or an edge of the bottom surface of the substrate by a distance greater than 0.1 mm.

In an embodiment, the electrode set further includes an auxiliary electrode. The auxiliary electrode extends to a position between the meltable member and the first heating element, in a direction from the third electrode to the fourth electrode, thereby connecting to the meltable member.

In an embodiment, the electrode set further includes an electrically conductive via. The substrate has a sidewall connected to the top surface and the bottom surface. The third electrode does not extend to the sidewall, and has a first portion and a second portion disposed on the top surface and the bottom surface of the substrate, respectively. The electrically conductive via penetrates the top surface and the bottom surface of the substrate, by which the first portion of the third electrode is electrically connected to the second portion of the third electrode.

In an embodiment, the protection device further includes a first insulating layer and a second insulating layer. The first insulating layer is disposed between the auxiliary electrode and the first heating element, and extends toward the first electrode and the second electrode to attach to the top surface of the substrate, wherein the first insulating layer is not in contact with the first electrode, the second electrode, and the meltable member. The second insulating layer covers the second heating element, and extends toward the first electrode and the second electrode to attach to the bottom surface of the substrate, wherein the second insulating layer is not in contact with the first electrode and the second electrode.

In an embodiment, the heater further includes a third heating element. A ratio of an electrical resistance of the first heating element to an electrical resistance of the second heating element to an electrical resistance of the third heating element is defined as x:y:z, wherein each of x, y, and z ranges from 1 to 1.1.

In an embodiment, the protection device further includes a cover member with an accommodation space. The cover member is connected to the substrate, by which the meltable member is disposed in the accommodation space and isolated from external environment. The cover member does not include a heater.

In an embodiment, the cover member is made of a material selected from the group consisting of polybenzimidazole, polyetheretherketone, polyphenylene sulfide, liquid crystal polymer, polyphthalamide, and combinations thereof. The substrate is made of a material selected from the group consisting of aluminum oxide, aluminum nitride, zirconium oxide, glass, ceramic, and combinations thereof.

In an embodiment, the protection device further includes another substrate. The another substrate has a top surface and a bottom surface opposite to the top surface, wherein the top surface of the another substrate is in contact with the bottom surface of the substrate and the second heating element, by which the second heating element is fully enclosed between the substrate and the another substrate.

In accordance with an aspect of the present invention, a protection device includes a substrate, a heater, and a meltable member. The substrate has a top surface and a bottom surface opposite to the top surface. The heater includes a first heating element, a second heating element, and a third heating element. The first heating element is disposed on the top surface, and the second heating element is disposed on the bottom surface. The third heating element is disposed above the first heating element, wherein the third heating element and the first heating element are separated by an insulating layer. The substrate has a first surface area. The first heating element has a second surface area, the second heating element has a third surface area, and the third heating element has a fourth surface area. If the first surface area is taken as 100%, the sum of the second surface area, the third surface area, and the fourth surface area ranges from 50% to 70%. The meltable member is disposed above the third heating element, by which the meltable member is heated up and blown by the heater during an over-voltage event.

In an embodiment, the sum of the second surface area, the third surface area, and the fourth surface area is 60%.

In an embodiment, a ratio of an electrical resistance of the first heating element to an electrical resistance of the second heating element to an electrical resistance of the third heating element is defined as x:y:z, wherein each of x, y, and z ranges from 1 to 1.1.

In an embodiment, the protection device further includes a cover member with an accommodation space. The cover member is connected to the substrate, by which the meltable member is disposed in the accommodation space and isolated from external environment. The cover member does not include a heater.

In accordance with an aspect of the present invention, a protection device includes a substrate set, a heater, and a meltable member. The substrate set has a first substrate and a second substrate, wherein the first substrate has a top surface and a bottom surface opposite to the top surface, and the second substrate is disposed on the bottom surface. The heater includes a first heating element, a second heating element, and a third heating element. The first heating element is disposed on the top surface, and the second heating element is disposed on the bottom surface, by which the second heating element is in contact with the second substrate, and is enclosed between the first substrate and the second substrate. The third heating element is disposed below the second substrate. The first substrate has a first surface area. The first heating element has a second surface area, the second heating element has a third surface area, and the third heating element has a fourth surface area. If the first surface area is taken as 100%, the sum of the second surface area, the third surface area, and the fourth surface area ranges from 50% to 70%. The meltable member is disposed above the first heating element, by which the meltable member is heated up and blown by the heater during an over-voltage event.

In an embodiment, the sum of the second surface area, the third surface area, and the fourth surface area is 60%.

In an embodiment, a ratio of an electrical resistance of the first heating element to an electrical resistance of the second heating element to an electrical resistance of the third heating element is defined as x:y:z, wherein each of x, y, and z ranges from 1 to 1.1.

In an embodiment, the protection device further includes a cover member with an accommodation space. The cover member is connected to the substrate set, by which the meltable member is disposed in the accommodation space and isolated from external environment. The cover member does not include a heater.

### BRIEF DESCRIPTION OF THE DRA WINGS

The present application will be described according to the appended drawings in which:

FIG. 1 shows a cross-sectional view of a known protection device;

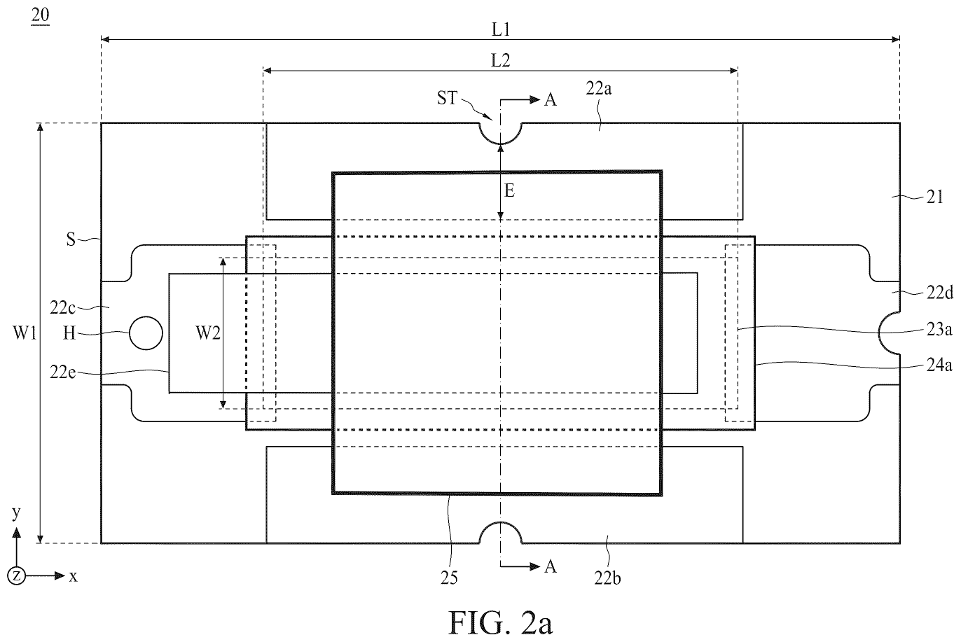

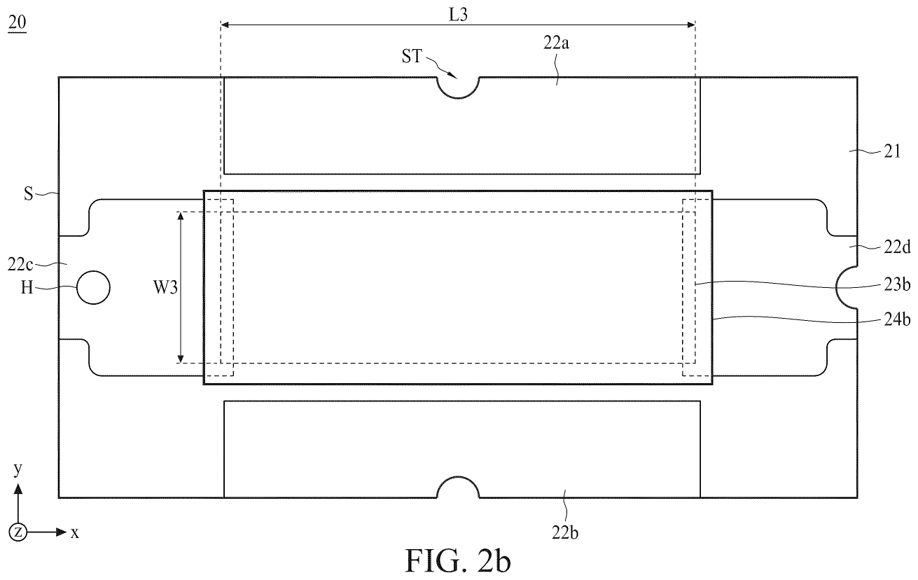

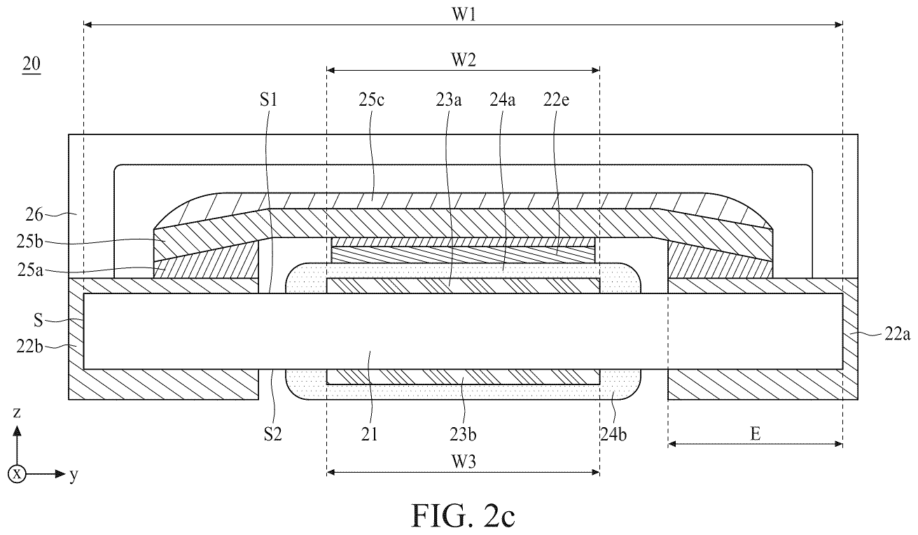

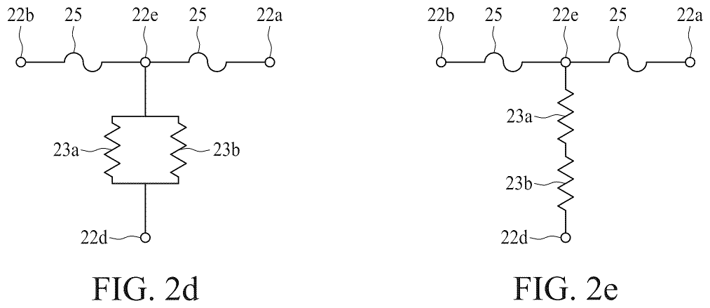

FIG. 2a shows a top view of a protection device of the present invention;

FIG. 2b shows a bottom view of the protection device in FIG. 2a;

FIG. 2c shows a cross-sectional view of the protection device along the line AA depicted in FIG. 2a;

FIG. 2d shows an equivalent circuit diagram of the protection device in FIG. 2a;

FIG. 2e shows an equivalent circuit diagram of another embodiment of the protection device in FIG. 2a;

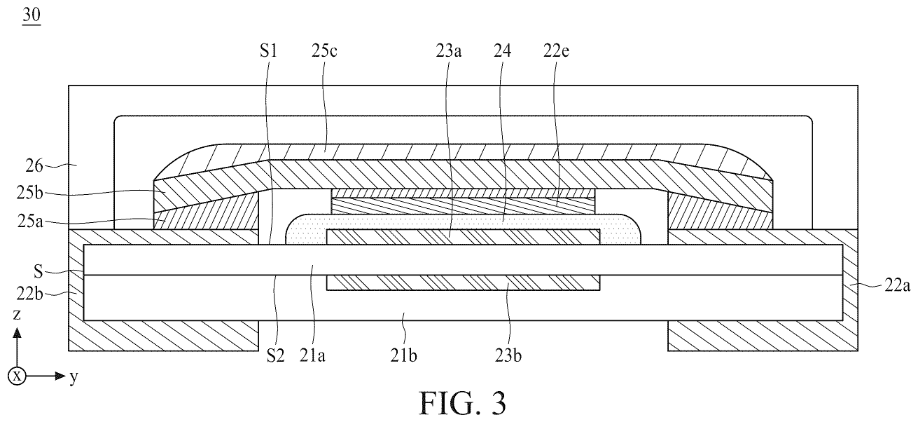

FIG. 3 to FIG. 5 show various embodiments of the protection device of the present invention; and

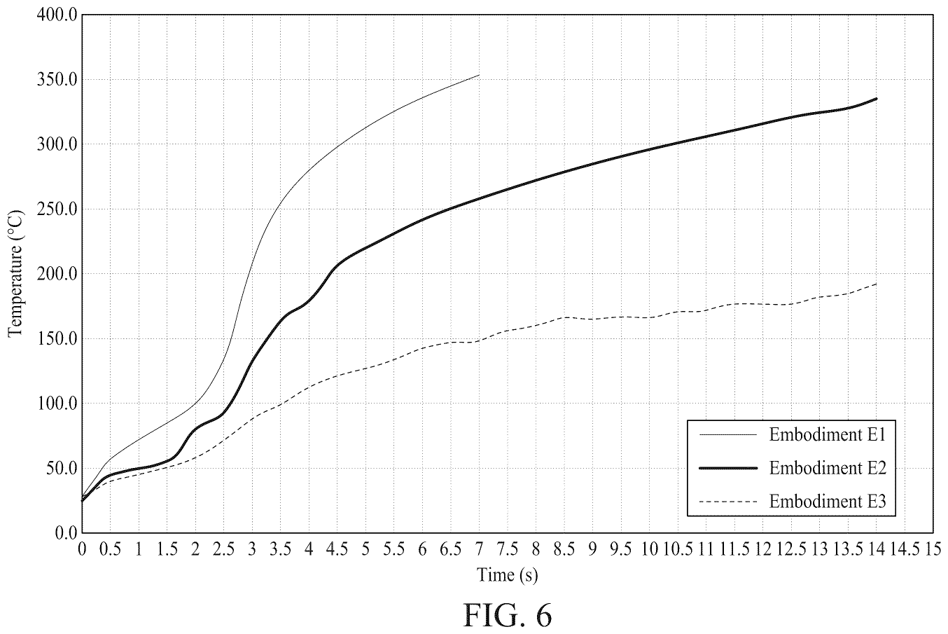

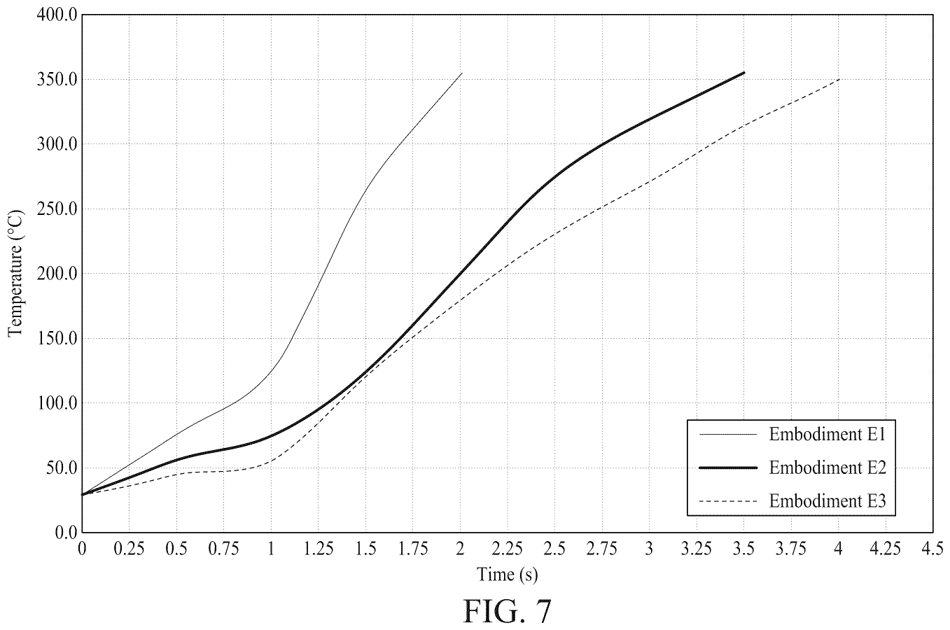

FIG. 6 and FIG. 7 show the heating rates of a meltable member of the present invention at 14 W and 43 W, respectively.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

Please refer to FIG. 2a and FIG. 2b, which show the top side and bottom side of a protection device 20 of the present invention, respectively. The protection device 20 includes a substrate 21, an electrode set, a heater, and a meltable member 25. The meltable member 25 may consist of a single metal layer or a plurality of metal layers and a covering layer, and it can be quickly blown in the events of over-voltage, over-current, and/or over-temperature, thereby protecting the electronic apparatus therefrom. The electrode set includes a first electrode 22a, a second electrode 22b, a third electrode 22c, a fourth electrode 22d, and an auxiliary electrode 22e. The first electrode 22a, the second electrode 22b, the third electrode 22c, and the fourth electrode 22d are printed on the substrate 21. The auxiliary electrode 22e perpendicularly protrudes from the third electrode 22c along the z-axis, and extends parallel to the substrate 21 along the x-axis and toward the right side in top view. The first electrode 22a is electrically connected to an input terminal, and the second electrode 22b is electrically connected to an output terminal of a power supply. The meltable member 25 is not attached to the substrate 21 and bridges the first electrode 22a and the second electrode 22b, thus being connected in series with the electronic apparatus to be protected (such as a battery). When the current or temperature becomes excessively large or high, the meltable member 25 is heated up and consequently blown, thereby preventing the battery from exploding during the charge or discharge process. To further enhance the blowing efficiency of the meltable member 25, the heater is disposed on both the top side and bottom side of the substrate 21. More specifically, the heater includes a first heating element 23a and a second heating element 23b. The first heating element 23a is disposed on the top side of the substrate 21 as shown in FIG. 2a, and the second heating element 23b is disposed on the bottom side of the substrate 21 as shown in FIG. 2b. The first heating element 23a is printed on the top side of the substrate 21 and is connected to the third electrode 22c and the fourth electrode 22d. As a result, the first heating element 23a is positioned below the meltable member 25 and the auxiliary electrode 22e. The second heating element 23b is printed on the bottom side of the substrate 21 and is also connected to the third electrode 22c and the fourth electrode 22d. The meltable member 25 and the heater are connected to a switch and a detecting unit (not shown). If the detecting unit detects an over-voltage event, the switch enables the heater to be electrically conductive. The current flows through the heater to generate heat to melt and blow the meltable member 25. The heater may be made of ruthenium oxide, nickel-chromium alloy, lead-germanium alloy, silicon-germanium alloy, or combinations thereof. In addition, the auxiliary electrode 22e physically contacts the meltable member 25. More specifically, the auxiliary electrode 22e extends to a position between the meltable member 25 and the first heating element 23a, in a direction from the third electrode 22c to the fourth electrode 22d along the x-axis, thereby connecting to the meltable member 25. The auxiliary electrode 22e facilitates the transfer of heat generated by the heater and adsorbs the molten part of the meltable member 25 during operation. The protection device 20 further includes a first insulating layer 24a and a second insulating layer 24b, which cover the first heating element 23a and the second heating element 23b, respectively. The first insulating layer 24a covers the first heating element 23a, and extends beyond the first heating element 23a in directions (along the y-axis) toward both the first electrode 22a and the second electrode 22b to attach to the substrate 21. Similarly, the second insulating layer 24b covers the second heating element 23b, and extends beyond the second heating element 23b in directions (along the y-axis) toward both the first electrode 22a and the second electrode 22b to attach to the substrate 21. In FIG. 2a and FIG. 2b, it is understood that the solid line is used to illustrate the exposed portion as viewed from the top or bottom, while the dashed line is used to illustrate the covered portion as viewed from the top or bottom. Accordingly, in FIG. 2a, the first heating element 23a, the first insulating layer 24a, the auxiliary electrode 22e, and the meltable member 25 are sequentially stacked on the substrate 21; and in FIG. 2b, the second heating element 23b and the second insulating layer 24b are sequentially stacked on the substrate 21.

It is noted that the present disclosure places the first heating element 23a and the second heating element 23b on the same substrate 21, and controls their surface areas within a specific range. The details are described below. The top-view area and the bottom-view area of the substrate 21 (i.e., the surface area of the substrate 21 in FIG. 2a and the surface area of the substrate 21 in FIG. 2b) are equal. In FIG. 2a, the top-view area of the substrate 21 is defined as a first surface area, and the top-view area of the first heating element 23a is defined as a second surface area. In FIG. 2b, the bottom-view area of the second heating element 23b is defined as a third surface area. The substrate 21 has a first length L1 and a first width W1, and the product of the first length L1 and the first width W1 equals the first surface area. The first heating element 23a has a second length L2 and a second width W2, and the product of the second length L2 and the second width W2 equals the second surface area. The second heating element 23b has a third length L3 and a third width W3, and the product of the third length L3 and the third width W3 equals the third surface area. The first length L1, the second length L2, and the third length L3 are substantially parallel to the x-axis. The first width W1, the second width W2, and the third width W3 are substantially parallel to the y-axis. By installing at least two heating elements, such as the first heating element 23a and the second heating element 23b, the heating area of the heater can be increased.

In the present invention, if the first surface area is taken as 100%, the sum of the second surface area and the third surface area ranges from 18% to 72%, such as 18%, 24%, 30%, 36%, 42%, 48%, 54%, 60%, 66%, or 72%. The second surface area of the first heating element 23a may be equal to or different from the third surface area of the second heating element 23b, as long as their sum falls within the aforementioned range. If the sum of the second surface area and the third surface area is less than 18%, the generated heat by the heater will be insufficient to melt the meltable member 25. Moreover, if the second surface area (or the third surface area) is less than 9%, it becomes too small to be precisely controlled during the printing process. If the sum of the second surface area and the third surface area is greater than 72%, the issue of overheating arises. This issue can lead to incomplete blowout of the meltable member 25, structural deficiencies, or other problems. For example, the heater may suddenly burn out due to extremely high energy when the power supply is turned on, before the heat can be transferred. In other cases, the extremely high energy from the heater may cause an explosion of the substrate 21 or a cover member 26, thereby further compromising other components (i.e., the components to be protected) around the protection device 20. In an preferred embodiment, if the first surface area is taken as 100%, the sum of the second surface area and the third surface area ranges from 42% to 70%.

In addition, the total surface area of the heater should not be excessively large, as it may affect the configuration of the electrodes. For example, the first electrode 22a needs to extend inward from an edge of the substrate 21 by a distance. The distance may be referred to as an edge distance E. The edge distance E should be at least 0.1 mm. The electrodes are made from silver paste, which has better electrical conductivity than that of the meltable member 25. If the edge distance E is less than 0.1 mm, issues with low electrical conductivity may arise. Additionally, if the edge distance E is too narrow, it becomes difficult to precisely control the printing area of the electrodes and difficult to weld the meltable member 25 with ease. It is noted that the substrate 21 may have a sidewall trench ST at the location of the first electrode 22a. The first electrode 22a on the top side of the substrate 21 (i.e., the first electrode 22a in FIG. 2a) can be electrically connected to the first electrode 22a on the bottom side of the substrate 21 (i.e., the first electrode 22a in FIG. 2b) through the sidewall trench ST. When the protection device 20 is welded to an external device, the sidewall trench ST can be used to accommodate solder for welding. The electrode set may further include an electrically conductive via H. In the present invention, the substrate 21 has a sidewall S connected to a top surface S1 and a bottom surface S2. The third electrode 22c does not extend to the sidewall S, and has a first portion and a second portion disposed on the top surface S1 and the bottom surface S2 of the substrate 21, respectively. That is, the first portion of the third electrode 22c is disposed on the top side of the substrate 21, and the second portion of the third electrode 22c is disposed on the bottom side of the substrate 21. The electrically conductive via H penetrates the top surface S1 and the bottom surface S2 of the substrate 21, by which the first portion of the third electrode 22c is electrically connected to the second portion of the third electrode 22c. It is worth noting that the present invention increases the total surface area of the heater on the same substrate 21 without sacrificing design flexibility. For example, in some cases, the electrically conductive via H may be required based on the design needs, which necessitates moving the inner edge of the third electrode 22c inward. This can reduce the surface area of the heater. Such a reduction may lead to an insufficient coverage by the heater and diminish heating efficiency, especially if only one heating element is present on the substrate. However, the present invention includes at least two heating elements (i.e., the first heating element 23a and the second heating element 23b). As long as the sum of the second surface area of the first heating element 23a and the third surface area of the second heating element 23b is at least 18%, the meltable member 25 can be effectively blown. The design of the electrically conductive via H does not compromise the performance of the heater of the present invention. It is understood that the design of the sidewall trench ST can be applied to the second electrode 22b, the third electrode 22c, and the fourth electrode 22d, while the design of the electrically conductive via H can be applied to the first electrode 22a, the second electrode 22b, and the fourth electrode 22d.

Please refer to FIG. 2c, which shows a cross-sectional view of the protection device 20 along the line AA depicted in FIG. 2a.

The meltable member 25 includes a core metal layer 25b and a top covering layer 25c disposed above the core metal layer 25b. Through a connecting layer 25a, both ends of the meltable member 25 is connected to the first electrode 22a and the second electrode 22b, respectively, while its center part is connected to the bottom auxiliary electrode 22e. The connecting layer 25a may be solder. The substrate 21 has the top surface S1 and the bottom surface S2 opposite to the top surface S1 (i.e., the aforementioned top side and bottom side of the substrate 21, respectively). The area of the top surface S1 is the first surface area as previously mentioned. The heater includes the first heating element 23a disposed on the top surface S1 and the second heating element 23b disposed on the bottom surface S2. In other words, in the present invention, if the area of the top surface S1 is taken as 100%, the sum of the second surface area of the first heating element 23a and the third surface area of the second heating element 23b ranges from 18% to 72%. In one embodiment, in order to enhance the process's convenience, the second surface area of the first heating element 23a is equal to the third surface area of the second heating element 23b. If the second surface area of the first heating element 23a is equal to the third surface area of the second heating element 23b, there is no need to use two screens with different sizes during the formation of the first heating element 23a and the second heating element 23b, significantly improving the convenience during mass production. In one embodiment, the second surface area of the first heating element 23a is smaller than the third surface area of the second heating element 23b because additional components need to be disposed on the top surface S1 based on design requirements, which limits the size of the second surface area of the first heating element 23a. In this circumstance, since the sum of the second surface area of the first heating element 23a and the third surface area of the second heating element 23b still ranges from 18% to 72%, the performance of the blowing action is not compromised by the design change on the top surface S1.

It is understood that an electrical resistance of the first heating element 23a may differ from that of the second heating element 23b, allowing the protection device to withstand higher power or vary its protection range in voltage. In some embodiments, a ratio of electrical resistance of the first heating element 23a divided by electrical resistance of the second heating element 23b is equal to or less than 2, such as 0.8, 0.9, 1, 1.1, 1.2, 1.3, 1.4, 1.5, 1.6, 1.7, 1.8, 1.9, or 2. Preferably, the aforementioned ratio of the electrical resistance of the first heating element 23a divided by the electrical resistance of the second heating element 23b ranges from 1 to 1.6. If the ratio ranges from 1 to 1.6, the heater can withstand a power of 400 W without burnout.

In some embodiments, the area of the top surface S1 may be different from the area of the bottom surface S2 of the substrate 21. For example, a width of the bottom surface S2 along the y-axis may be greater than the first width W1 of the top surface S1 along the y-axis, thereby forming a trapezoidal cross-section (not shown) with a wider bottom and a narrower top. This design allows the sidewall trench ST to extend inward at an angle from the bottom surface S2, facilitating the phenomenon of solder climbing. Additionally, the distance that the electrode set extends inward from an edge of the top surface S1 or an edge of the bottom surface S2 of the substrate 21 is the edge distance E, as previously mentioned. As exemplified in FIG. 2c, the edge distance E is the distance that the first electrode 22a extends inward from the center of the sidewall trench ST on either the top surface S1 or the bottom surface S2.

As described above, the heater is covered by the first insulating layer 24a and the second insulating layer 24b. The first insulating layer 24a is disposed between the auxiliary electrode 22e and the first heating element 23a, and extends toward the first electrode 22a and the second electrode 22b along the y-axis, attaching to the top surface S1 of the substrate 21. The first insulating layer 24a is not in contact with the first electrode 22a, the second electrode 22b, and the meltable member 25. The second insulating layer 24b covers the second heating element 23b, and extends toward the first electrode 22a and the second electrode 22b along the y-axis, attaching to the bottom surface S2 of the substrate 21. Similarly, the second insulating layer 24b is not in contact with the first electrode 22a and the second electrode 22b. Both the first insulating layer 24a and the second insulating layer 24b are not in contact with the first electrode 22a and the second electrode 22b, which helps to concentrate and direct the generated heat by the heater upward toward the meltable member 25.

The protection device may further include the cover member 26 with an accommodation space. For ease of discussion, the cover member 26 is not shown in FIG. 2a. The cover member 26 is connected to the substrate 21, by which the meltable member 25 is disposed in the accommodation space and isolated from external environment. It is understood that the cover member 26 does not include any heating elements. Specifically, the cover member 26 does not include a heater or any components used for heating and accelerating the blowing action of the meltable member 25. In this way, design considerations for the cover member 26 are quite simple. The cover member 26 can be quickly manufactured using injection molding, and there is no need to print heating elements and related components onto it afterward, making the manufacturing process simple. The composition of the cover member 26 may differ from that of the substrate 21. The cover member 26 may be made of a material selected from the group consisting of polybenzimidazole (PBI), polyetheretherketone (PEEK), polyphenylene sulfide (PPS), liquid crystal polymer (LCP), polyphthalamide (PPA), and combinations thereof. The substrate 21 may be made of a material selected from the group consisting of aluminum oxide, aluminum nitride, zirconium oxide, glass, ceramic, and combinations thereof.

Please refer to FIG. 2d, which shows an equivalent circuit diagram of the protection device 20. In FIG. 2d, the first heating element 23a and the second heating element 23b are electrically connected in parallel. That is, two terminals of the first heating element 23a are connected to the third electrode 22c and the fourth electrode 22d along the x-axis on the top surface S1 of the substrate 21 (as shown in FIG. 2a), while two terminals of the second heating element 23b are connected to the third electrode 22c and the fourth electrode 22d along the x-axis on the bottom surface S2 of the substrate 21 (as shown in FIG. 2b), by which the first heating element 23a and the second heating element 23b are electrically connected in parallel. In other embodiments, the first heating element 23a and the second heating element 23b are electrically connected in series depending on the design requirements, and an equivalent circuit diagram of this configuration is shown in FIG. 2e. The present invention may have various embodiments. Please refer to FIG. 3 through FIG. 5 for additional details.

FIG. 3 shows a cross-sectional view of a protection device 30 in accordance with an embodiment of the present invention. The primary difference between FIG. 3 and FIG. 2c lies in the number of substrates and the position of the second heating element 23b. The protection device 30 includes a substrate set consisting of a plurality of substrates (e.g., a first substrate 21a and a second substrate 21b), and the second heating element 23b is laminated between these two substrates. More specifically, the first substrate 21a has the top surface S1 and the bottom surface S2 opposite to the top surface S1, while the second substrate 21b also has a top surface and a bottom surface opposite to the top surface. The top surface of the second substrate 21b is in contact with both the second heating element 23b and the bottom surface S2 of the first substrate 21a, fully enclosing the second heating element 23b between the first substrate 21a and the second substrate 21b. An insulating layer 24 is disposed between the auxiliary electrode 22e and the first heating element 23a, and extends toward the first electrode 22a and the second electrode 22b along the y-axis, attaching to the top surface S1 of the first substrate 21a. Clearly, the second heating element 23b is an embedded-type heating element, eliminating the need to print an insulating layer to cover it. It is noted that the same features previously mentioned are denoted by the same reference signs and have the same functions as described above. To avoid redundancy, further explanation will not be repeated herein.

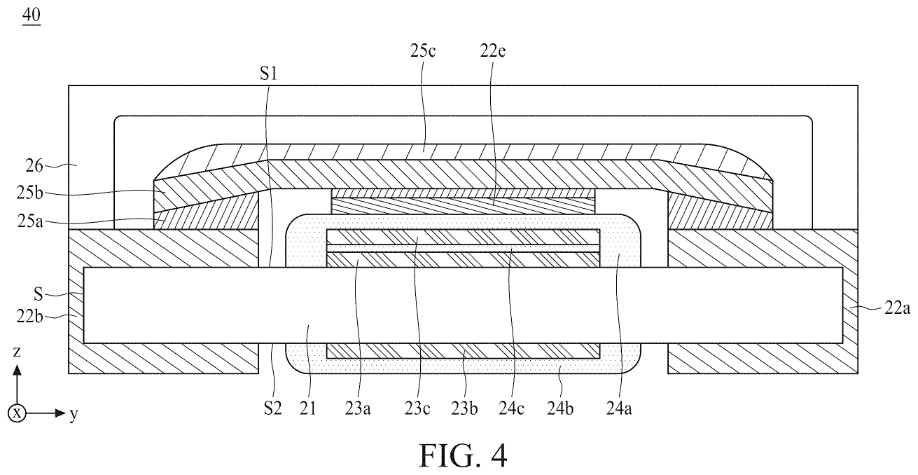

FIG. 4 shows a cross-sectional view of a protection device 40 in accordance with an embodiment of the present invention. The primary difference between FIG. 4 and FIG. 2c lies in the number of heating elements. The heater includes the first heating element 23a, the second heating element 23b, and a third heating element 23c. Correspondingly, the protection device 40 further includes a third insulating layer 24c besides the first insulating layer 24a and the second insulating layer 24b. As described above, the first heating element 23a and the second heating element 23b are printed on the top surface S1 and the bottom surface S2 of the substrate 21, respectively, and are covered by the first insulating layer 24a and the second insulating layer 24b. The first insulating layer 24a is disposed between the auxiliary electrode 22e and the first heating element 23a, and extends toward the first electrode 22a and the second electrode 22b along the y-axis, attaching to the top surface S1 of the substrate 21. The second insulating layer 24b covers the second heating element 23b, and extends toward the first electrode 22a and the second electrode 22b along the y-axis, attaching to the bottom surface S2 of the substrate 21. The third heating element 23c is disposed above the first heating element 23a, with the third insulating layer 24c laminated between them. In addition, electrical resistances of the first heating element 23a, the second heating element 23b, and the third heating element 23c are maintained within a specific range. In the present invention, a ratio of the electrical resistance of the first heating element 23a to the electrical resistance of the second heating element 23b to the electrical resistance of the third heating element 23c is defined as x:y:z, wherein each of x, y, and z ranges from 1 to 1.1. If x, y, and z fall within the range from 1 to 1.1, the heater can withstand an applied voltage of 43 V without burnout. For example, in one embodiment, with the total electrical resistance of the heater set to around 4Ω, the electrical resistance of the first heating element 23a may be about 12Ω, the electrical resistance of the second heating element 23b may be about 12Ω, and the electrical resistance of the third heating element 23c may be about 12Ω. Therefore, the ratio of x:y:z is 1:1:1. In this case, with x:y:z equal to 1:1:1, the heater can withstand an applied voltage of at least 43 V without burnout. It is noted that the same features previously mentioned are denoted by the same reference signs and have the same functions as described above. To avoid redundancy, further explanation will not be repeated herein.

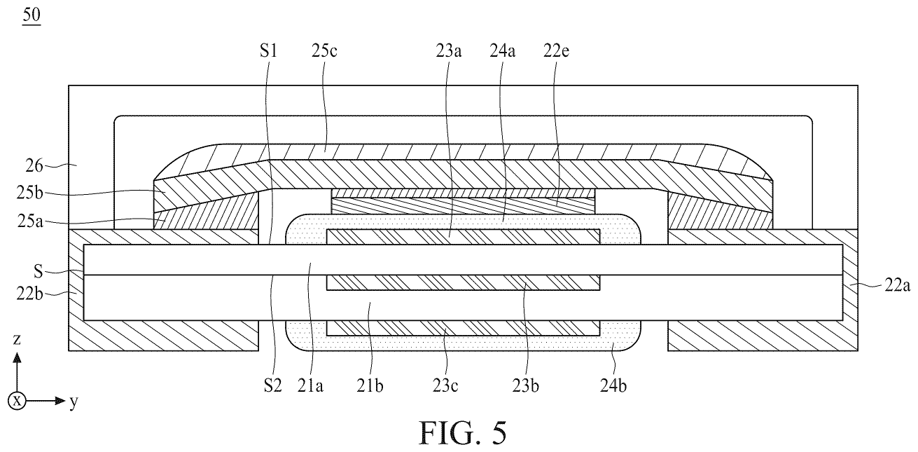

FIG. 5 shows a cross-sectional view of a protection device 50 in accordance with an embodiment of the present invention. The primary difference between FIG. 5 and FIG. 3 lies in the number of heating elements. The protection device 50 includes the substrate set consisting of a plurality of substrates (e.g., the first substrate 21a and the second substrate 21b), and the heater includes the first heating element 23a, the second heating element 23b, and the third heating element 23c. The second heating element 23b is laminated between the first substrate 21a and the second substrate 21b. The first substrate 21a has the top surface S1 and the bottom surface S2 opposite to the top surface S1, while the second substrate 21b also has the top surface and the bottom surface opposite to the top surface. The top surface of the second substrate 21b is in contact with both the second heating element 23b and the bottom surface S2 of the first substrate 21a, fully enclosing the second heating element 23b between the first substrate 21a and the second substrate 21b. The third heating element 23c is disposed on the bottom surface of the second substrate 21b, and the second insulating layer 24b covers the third heating element 23c. The first insulating layer 24a is disposed between the auxiliary electrode 22e and the first heating element 23a, and extends toward the first electrode 22a and the second electrode 22b along the y-axis, attaching to the top surface S1 of the first substrate 21a. The second insulating layer 24b covers the third heating element 23c, and extends toward the first electrode 22a and the second electrode 22b along the y-axis, attaching to the bottom surface of the second substrate 21b. The electrical resistances of the first heating element 23a, the second heating element 23b, and the third heating element 23c can be varied within the range as described above. It is noted that the same features previously mentioned are denoted by the same reference signs and have the same functions as described above. To avoid redundancy, further explanation will not be repeated herein.

To describe the protection device of the present invention more clearly, the following verification is provided.

TABLE 1

| | | | | Surface area | 14 W | | 43 W | |
|---|---|---|---|---|---|---|---|---|
| | Surface area | | | of one | Heating | | Heating | |
| | of one | | | heating | rate of | | rate of | |
| | heating | Surface area | Resistance | element/ | meltable | Blowing | meltable | Blowing |
| | element | of substrate | of heater | Surface area | member | time | member | time |
| Group | (mm²) | (mm²) | (Ω) | of substrate | (° C./s) | (s) | (° C./s) | (s) |
| E1 | 9.2 × 1.8 | 9.5 × 5 | 4.59 | 34.9% | 56 | 6.3 | 177.3 | 1.6 |
| E2 | 5.65 × 1.8 | 9.5 × 5 | 4.62 | 21.4% | 23.9 | 14.2 | 83.6 | 3.3 |
| E3 | 2.3 × 1.8 | 9.5 × 5 | 4.47 | 8.7% | — | — | 73.7 | 4.8 |

As shown in Table 1, test groups E1, E2, and E3 represent embodiments E1, E2, and E3 of the present invention, respectively. In this test, the top-view area of the first heating element 23a is equal to the bottom-view area of the second heating element 23b. Therefore, only one of their surface areas is shown in Table 1 for ease of discussion. The term “surface area of one heating element” refers to either the second surface area of the first heating element 23a or the third surface area of the second heating element 23b as previously mentioned. The term “surface area of substrate” refers to the first surface area of the substrate 21 as previously mentioned. More specifically, the substrate has the first length L1 of 9.5 mm and the first width W1 of 5 mm, resulting in the first surface area of 47.5 mm². The term “resistance of heater” refers to the total electrical resistance of the first heating element 23a and the second heating element 23b when connected in parallel. The heater is connected to an external power source, and its power can be adjusted to either 14 W or 43 W. Additionally, the length, width, and thickness of the meltable member 25 are 3.5 mm, 3.5 mm, and 0.08 mm, respectively.

In the embodiment E1, the length (i.e., the second length L2 or the third length L3) and the width (i.e., the second width W2 or the third width W3) of one heating element are 9.2 mm and 1.8 mm, respectively, resulting in a surface area of 16.56 mm². Therefore, in this case, if the substrate's surface area is taken as 100%, the surface area of one heating element of the embodiment E1 is about 34.9%. In the embodiment E2, the length and width of the heating element are 5.65 mm and 1.8 mm, respectively, resulting in a surface area of 10.17 mm². Therefore, in this case, if the substrate's surface area is taken as 100%, the surface area of one heating element of the embodiment E2 is about 21.4%. In the embodiment E3, the length and width of the heating element are 2.3 mm and 1.8 mm, respectively, resulting in a surface area of 4.14 mm². Therefore, in this case, if the substrate's surface area is taken as 100%, the surface area of one heating element of the embodiment E3 is about 8.7%. Considering measurement error and permissible tolerance, the sum of the second surface area and the third surface area in the embodiments E1 to E3 may vary within the range of 18% to 72%.

Please refer to Table 1, FIG. 6, and FIG. 7. FIG. 6 and FIG. 7 show the heating rates of the meltable member 25 at 14 W and 43 W, respectively. The horizontal axis represents the heating time, while the vertical axis represents the temperature. At a power of 14 W, the embodiments E1 and E2 can reach nearly 350° C. and blow the meltable member 25 in approximately 6 seconds and 14 seconds, respectively. In contrast, the embodiment E3 heats up slowly and cannot blow the meltable member 25 within 15 seconds. It is observed that as the surface area of the heater increases, the blowing time can be significantly reduced; however, the meltable member 25 cannot be blown with such low power if the surface area of the heater is too small (i.e., if the surface area of one heating element is less than 9%). Moreover, the maximum of the surface area of one heating element is approximately 36% due to the presence of other components installed on the substrate 21. At a power of 43 W, the embodiments E1 to E3 can blow the meltable member 25 in approximately 1 to 5 seconds. Similarly, as the surface area of the heater increases, the blowing time can be significantly reduced. From the above, it can be seen that when the surface area of one heating element is approximately 21% to 35%, the embodiments E1 and E2 can blow the meltable member 25 at both low and high power. In other words, in the embodiments E1 and E2, if the first surface area is taken as 100%, the sum of the second surface area and the third surface area can range from 42% to 70%.

TABLE 2

| | Resistance (Ω) | | | Resistance Ratio | | |
|---|---|---|---|---|---|---|
| | First heating | Second heating | | First heating element/ | Power | Pass |
| Group | element | element | Heater | Second heating element | (W) | rate |
| C1 | 4.45 | — | 4.45 | — | 250 | 100% |
| C2 | 4.54 | — | 4.54 | — | 280 | 60% |
| E4 | 9.52 | 9.45 | 4.74 | 1.0 | 400 | 100% |
| E5 | 10.32 | 8.26 | 4.59 | 1.2 | 400 | 100% |
| E6 | 10.44 | 6.56 | 4.03 | 1.6 | 400 | 100% |
| E7 | 11.22 | 6.34 | 4.05 | 1.8 | 400 | 20% |
| E8 | 11.43 | 6.49 | 4.14 | 1.8 | 320 | 60% |
| E9 | 12.42 | 6.34 | 4.20 | 2.0 | 300 | 40% |
| E10 | 12.53 | 6.38 | 4.23 | 2.0 | 280 | 60% |

As shown in Table 2, test groups C1 and C2 represent comparative examples C1 and C2, respectively, while test groups E4 to E10 represent embodiments E4 to E10 of the protective device 20 according to the present invention. The difference between the comparative examples and embodiments lies in the number of heating elements. The embodiments E4 to E10 have the same ratio of the surface area of one heating element as the embodiment E2. Each of the comparative examples C1 and C2 has only one heating element (i.e., the first heating element 23a), and its surface area is about 20% if the substrate's surface area is taken as 100%. The electrical resistances of the heater are generally the same in all groups, ranging from 4Ω to 5Ω. However, in the embodiments E4 to E10, the resistance ratio can be varied. The first heating element 23a has a higher electrical resistance, while the second heating element 23b has a lower electrical resistance. The ratio of the electrical resistance of the first heating element 23a divided by the electrical resistance of the second heating element 23b ranges from about 1 to 2. Fifteen samples (i.e., protective devices) are tested in each group, and the pass rate refers to the percentage of heaters that do not burn out under a specific power. As shown in Table 2, when the resistance ratio ranges from 1 to 1.6 (i.e., the embodiments E4 to E6), the heater can withstand a power of 400 W without burnout. Specifically, in the embodiment E4, all the heaters in the fifteen protective devices 20 were subjected to the power of 400 W, and they operated normally. Likewise, the same results were observed in the embodiments E5 and E6. In contrast, the pass rate of the comparative example C2 significantly decreases to 60% when subjected to a power of 280 W. It is clear that on the basis of the heater structure in FIG. 2c (i.e., the design in which the first heating element 23a and the second heating element 23b are disposed on the same substrate), the present invention further adjusts the resistance ratio to ensure compatibility with this structure, thereby significantly improving the power endurance.

TABLE 3

| | Resistance (Ω) | | | | |
|---|---|---|---|---|---|
| | First | Second | Third | | |
| | heating | heating | heating | | Voltage |
| Group | element | element | element | Heater | (V) |
| C3 | 4.46 | — | — | 4.46 | 18.5 |
| E11 | 9.25 | 9.35 | — | 4.65 | 23.5 |
| E12 | 12.52 | 12.45 | 12.54 | 4.17 | 43 |

As shown in Table 3, the test group C3 represents a comparative example C3, which has the same structure as the comparative examples C1 and C2, as previously mentioned. The test group E11 represents an embodiment E11 of the protective device 20 of the present invention, in which, if the substrate's surface area is taken as 100%, the surface area of each heating element is set to 20%; in other words, the sum of the top-view area of the first heating element 23a and the bottom-view area of the second heating element 23b is 40%. The test group E12 represents an embodiment E12 of the protective device 40 of the present invention, in which, if the substrate's surface area is taken as 100%, the surface area of each heating element is set to 20%; in other words, the sum of the top-view area of the first heating element 23a, the bottom-view area of the second heating element 23b, and the top-view area of the third heating element 23c is 60%. The electrical resistances of the heaters are generally the same in all groups, ranging from 4 $2 to 5 $2. In the embodiment E11, the electrical resistances of the first heating element 23a and the second heating element 23b are 9.25Ω and 9.35Ω, respectively, and the heater can withstand a voltage of 23.5 V without burnout. In the embodiment E12, the electrical resistances of the first heating element 23a, the second heating element 23b, and the third heating element 23c are 12.52 Ω, 12.45Ω, and 12.54Ω, respectively, and the heater can withstand a voltage of 43 V without burnout. The ratio of the electrical resistance of the first heating element 23a to the electrical resistance of the second heating element 23b to the electrical resistance of the third heating element 23c is approximately 1:1:1. Considering measurement error and permissible tolerance, each value in this ratio may range from 1 to 1.1, and the sum of the top-view area of the first heating element 23a, the bottom-view area of the second heating element 23b, and the top-view area of the third heating element 23c may range from 50% to 70%. From the above, the heater can withstand a higher voltage due to the installation of three heating elements.

The above-described embodiments of the present invention are intended to be illustrative only. Numerous alternative embodiments may be devised by persons skilled in the art without departing from the scope of the following claims.

What is claimed is:

1. A protection device, comprising:
a substrate having a top surface and a bottom surface opposite to the top surface;
a heater comprising a first heating element disposed on the top surface and a second heating element disposed on the bottom surface, wherein:
the substrate has a first surface area;
the first heating element has a second surface area, and the second heating element has a third surface area; and
if the first surface area is taken as 100%, the sum of the second surface area and the third surface area ranges from 18% to 72%; and
a meltable member disposed above the first heating element, whereby the meltable member is heated up and blown by the heater during an over-voltage event.

2. The protection device of claim 1, wherein the sum of the second surface area and the third surface area ranges from 42% to 70%, wherein:
at an applied power of 14 W, the meltable member is blown in 15 seconds; or
at an applied power of 43 W, the meltable member is blown in 5 seconds.

3. The protection device of claim 1, wherein a ratio of an electrical resistance of the first heating element divided by an electrical resistance of the second heating element is equal to or less than 2.

4. The protection device of claim 3, wherein the ratio of the electrical resistance of the first heating element divided by the electrical resistance of the second heating element ranges from 1 to 1.6.

5. The protection device of claim 1, wherein the second surface area of the first heating element is equal to the third surface area of the second heating element.

6. The protection device of claim 1, wherein the second surface area of the first heating element is smaller than the third surface area of the second heating element.

7. The protection device of claim 1, further comprising an electrode set having a first electrode, a second electrode, a third electrode, and a fourth electrode, wherein:
the first electrode and the second electrode are disposed opposite on the substrate, and the third electrode and the fourth electrode are disposed opposite on the substrate;
two terminals of the meltable member are connected to the first electrode and the second electrode, respectively;
two terminals of the first heating element are connected to the third electrode and the fourth electrode on the top surface of the substrate; and
two terminals of the second heating element are connected to the third electrode and the fourth electrode on the bottom surface of the substrate, whereby the first heating element and the second heating element are electrically connected in parallel.

8. The protection device of claim 7, wherein the electrode set extends inward from an edge of the top surface or an edge of the bottom surface of the substrate by a distance greater than 0.1 mm.

9. The protection device of claim 7, wherein the electrode set further comprises an auxiliary electrode, wherein the auxiliary electrode extends to a position between the meltable member and the first heating element, in a direction from the third electrode to the fourth electrode, thereby connecting to the meltable member.

10. The protection device of claim 9, wherein the electrode set further comprises an electrically conductive via, wherein:
the substrate has a sidewall connected to the top surface and the bottom surface;
the third electrode does not extend to the sidewall, and has a first portion and a second portion disposed on the top surface and the bottom surface of the substrate, respectively; and
the electrically conductive via penetrates the top surface and the bottom surface of the substrate, whereby the first portion of the third electrode is electrically connected to the second portion of the third electrode.

11. The protection device of claim 9, further comprising a first insulating layer and a second insulating layer, wherein:
the first insulating layer is disposed between the auxiliary electrode and the first heating element, and extends toward the first electrode and the second electrode to attach to the top surface of the substrate, wherein the first insulating layer is not in contact with the first electrode, the second electrode, and the meltable member; and
the second insulating layer covers the second heating element, and extends toward the first electrode and the second electrode to attach to the bottom surface of the substrate, wherein the second insulating layer is not in contact with the first electrode and the second electrode.

12. The protection device of claim 1, wherein the heater further comprises a third heating element, wherein:
a ratio of an electrical resistance of the first heating element to an electrical resistance of the second heating element to an electrical resistance of the third heating element is defined as x:y:z, wherein each of x, y, and z ranges from 1 to 1.1.

13. The protection device of claim 1, further comprising a cover member with an accommodation space, wherein:
the cover member is connected to the substrate, whereby the meltable member is disposed in the accommodation space and isolated from external environment; and
the cover member does not comprise a heater.

14. The protection device of claim 13, wherein the cover member is made of a material selected from the group consisting of polybenzimidazole, polyetheretherketone, polyphenylene sulfide, liquid crystal polymer, polyphthalamide, and combinations thereof, and wherein the substrate is made of a material selected from the group consisting of aluminum oxide, aluminum nitride, zirconium oxide, glass, ceramic, and combinations thereof.

15. The protection device of claim 1, further comprising another substrate, wherein the another substrate has a top surface and a bottom surface opposite to the top surface, wherein the top surface of the another substrate is in contact with the bottom surface of the substrate and the second heating element, whereby the second heating element is fully enclosed between the substrate and the another substrate.

16. A protection device, comprising:
a substrate having a top surface and a bottom surface opposite to the top surface;
a heater comprising a first heating element, a second heating element, and a third heating element, wherein:
the first heating element is disposed on the top surface, and the second heating element is disposed on the bottom surface;
the third heating element is disposed above the first heating element, wherein the third heating element and the first heating element are separated by an insulating layer;
the substrate has a first surface area;
the first heating element has a second surface area, the second heating element has a third surface area, and the third heating element has a fourth surface area; and
if the first surface area is taken as 100%, the sum of the second surface area, the third surface area, and the fourth surface area ranges from 50% to 70%; and
a meltable member disposed above the third heating element, whereby the meltable member is heated up and blown by the heater during an over-voltage event.

17. The protection device of claim 16, wherein the sum of the second surface area, the third surface area, and the fourth surface area is 60%.

18. The protection device of claim 16, wherein a ratio of an electrical resistance of the first heating element to an electrical resistance of the second heating element to an electrical resistance of the third heating element is defined as x:y:z, wherein each of x, y, and z ranges from 1 to 1.1.

19. The protection device of claim 16, further comprising a cover member with an accommodation space, wherein:
the cover member is connected to the substrate, whereby the meltable member is disposed in the accommodation space and isolated from external environment; and
the cover member does not comprise a heater.

20. A protection device, comprising:
a substrate set having a first substrate and a second substrate, wherein the first substrate has a top surface and a bottom surface opposite to the top surface, and the second substrate is disposed on the bottom surface;
a heater comprising a first heating element, a second heating element, and a third heating element, wherein:
the first heating element is disposed on the top surface, and the second heating element is disposed on the bottom surface, whereby the second heating element is in contact with the second substrate, and is enclosed between the first substrate and the second substrate;
the third heating element is disposed below the second substrate;
the first substrate has a first surface area;
the first heating element has a second surface area, the second heating element has a third surface area, and the third heating element has a fourth surface area; and
if the first surface area is taken as 100%, the sum of the second surface area, the third surface area, and the fourth surface area ranges from 50% to 70%; and
a meltable member disposed above the first heating element, whereby the meltable member is heated up and blown by the heater during an over-voltage event.

21. The protection device of claim 20, wherein the sum of the second surface area, the third surface area, and the fourth surface area is 60%.

22. The protection device of claim 20, wherein a ratio of an electrical resistance of the first heating element to an electrical resistance of the second heating element to an electrical resistance of the third heating element is defined as x:y:z, wherein each of x, y, and z ranges from 1 to 1.1.

23. The protection device of claim 20, further comprising a cover member with an accommodation space, wherein:
the cover member is connected to the substrate set, whereby the meltable member is disposed in the accommodation space and isolated from external environment; and
the cover member does not comprise a heater.
